(19) United States
(12) Patent Application Publication
(10) Pub. No.: US 2024/0141669 A1
(43) Pub. Date: May 2, 2024

(54) SYSTEMS AND METHODS FOR CONTROLLING POOL CLEANING DEVICES AND OTHER EQUIPMENT FOR SWIMMING POOLS OR SPAS

(71) Applicant: ZODIAC POOL SYSTEMS LLC, Carlsbad, CA (US)

(72) Inventors: E. Keith McQueen, Vista, CA (US); Mike Reeves, Carlsbad, CA (US); Mehdi Chafik, Tornefeuille (FR)

(73) Assignee: ZODIAC POOL SYSTEMS LLC, Carlsbad, CA (US)

(21) Appl. No.: 18/385,518

(22) Filed: Oct. 31, 2023

Related U.S. Application Data
(60) Provisional application No. 63/421,354, filed on Nov. 1, 2022.

(51) Int. Cl. E04H 4/16

(52) U.S. Cl. CPC E04H 4/1654

(57) ABSTRACT

A method of controlling an automatic swimming pool cleaner includes comparing characteristics of at least two similar electromechanical devices of the automatic swimming pool cleaner to establish a normal relationship between the at least two similar electromechanical devices. The method includes identifying abnormal behavior of the automatic swimming pool cleaner based on a divergence from the normal relationship.

### REFERENCE TO RELATED APPLICATION

This application claims the benefit of U.S. Provisional Patent Application No. 63/421,354, filed on Nov. 1, 2022, and entitled SYSTEMS AND METHODS FOR CONTROLLING POOL CLEANING DEVICES AND OTHER EQUIPMENT FOR SWIMMING POOLS OR SPAS, the content of which is hereby incorporated by reference in its entirety.

### FIELD OF THE INVENTION

This application relates to cleaning devices and other equipment for water-containing vessels such as swimming pools and spas, among others.

### BACKGROUND OF THE INVENTION

Swimming pools and spas often include equipment that perform various actions relating to the water of the swimming pools or spas. As examples, a swimming pool or spa system may include robotic cleaners such as but not limited to automatic swimming pool cleaners (APCs), pumps for circulating the water, heaters for heating the water, etc. Such equipment may have various devices or components, and over time and for various reasons, the equipment may behave abnormally and/or fail. Traditionally, the identification of abnormally behaving and/or failed equipment has relied on observation by the pool owner or other person and a determination by the pool owner to initiate servicing of the equipment. Such servicing may include having a technician come out to troubleshoot the issue and/or may include sending the equipment to a dealer or servicer for servicing and/or replacement. Regardless of the type of action required, abnormal behavior, failure, and/or servicing in general is inconvenient to a pool owner and disrupts maintenance of the pool or spa.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method of controlling an APC includes (i) comparing characteristics of at least two similar electromechanical devices of the APC to establish a normal relationship between the at least two similar electromechanical devices, and (ii) identifying abnormal behavior of the APC based on a divergence from the normal relationship.

According to various embodiments, an APC for a swimming pool or spa includes a controller, a first electromechanical device, and a second electromechanical device. The controller may (i) determine a normal relationship between the first electromechanical device and the second electromechanical device by comparing a characteristic of the first electromechanical device with a characteristic of the second electromechanical device and (ii) identify abnormal behavior of the APC based on a divergence from the normal relationship.

According to some embodiments, a method includes receiving signals from at least two devices of an APC, determining a normal relationship between the at least two devices based on the received signals, and identifying behavior of the APC based on a change in relationship between the signals, wherein the signals correspond with operating characteristics of the at least two devices.

According to certain embodiments, an APC for a swimming pool or spa includes a controller and at least two devices, each having an operating characteristic. The controller may receive signals from the at least two devices of the APC, determine a normal relationship between the at least two devices based on the received signals, and identify behavior of the APC based on a change in relationship between the signals.

According to various embodiments, a method of controlling equipment of a pool or spa system includes (i) determining a normal relationship between a first device and a second device by comparing an operating characteristic of the first device with an operating characteristic of the second device, and (ii) identifying a change in behavior of the pool or spa system based on a change in relationship between the operating characteristic of the first device and the operating characteristic of the second device.

According to some embodiments, a method includes comparing characteristics of at least two similar electromechanical devices of an APC and predicting a time period to failure of the APC based on a change in relationship between characteristics of the at least two similar electromechanical devices.

According to various embodiments, a method includes receiving data from a plurality of devices of an APC, determining a normal relationship between the plurality of devices of the APC based on the received data, and identifying a condition of the APC based on a change in a pattern of the received data from the normal relationship.

According to certain embodiments, a method includes comparing a plurality devices of an APC to each other with regards to a common characteristic, and identifying an abnormal condition of the APC based on a divergent relationship of the common characteristic of the plurality of devices of the APC.

According to various embodiments, a pool system includes a controller and a plurality of devices. The controller may determine a normal relationship fora first device of the plurality of devices by comparing an operating characteristic of the first device with either an operating characteristic of a second device of the plurality of devices or an average value of an operating characteristic of the plurality of devices. The controller may identify a change in behavior of the pool or spa system based on a change in relationship between the operating characteristic of the first device and the operating characteristic of the second device

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

FIG. 2 illustrates pool equipment of the pool system of FIG. 1 according to embodiments.

FIG. 3 illustrates pool equipment of the pool system of FIG. 1 according to embodiments.

FIG. 4 illustrates components of the pool equipment of FIG. 3.

FIG. 5 illustrates a method of controlling pool equipment of the pool system of FIG. 1 according to embodiments.

FIG. 6 illustrates a relationship between components of the pool system of FIG. 1 according to embodiments.

FIG. 7 illustrates a relationship between components of the pool system of FIG. 1 according to embodiments.

### DESCRIPTION OF THE INVENTION

Described herein are pool equipment for swimming pools and spas with systems and associated methods for identifying a behavior and/or operation of the pool equipment. In various embodiments, the systems and methods described herein identify and monitor behavior and/or operation of the pool equipment based on relationships between characteristics of two or more components or devices of the pool equipment. Such components of the equipment may be electrical components, mechanical components, electromechanical components, and/or other devices or components as desired. The two or more components may be similar components (e.g., both traction motors, pumps, sensors, etc.) and/or dissimilar components. The systems and methods described herein may identify a normal relationship between two or more components of a particular piece of pool equipment, and may further use a change in relationship as an indicator that the particular piece of equipment is behaving abnormally and/or failing (and/or to otherwise identify a condition and/or status of the equipment). In certain embodiments, the systems and methods described herein may determine a control response and/or implement a control response based on a change from the normal relationship. Such control responses may include, but are not limited to, predicting a time period to failure for the equipment, changing a monitoring characteristic (e.g., frequency of monitoring of relationship, type of data monitored, etc.), sending a notification or alert to a pool owner or servicer, providing an alert on the piece of equipment, providing diagnostic information, controlling the equipment, initiating shipping and/or sending of a replacement piece of equipment, communicating to an end consumer to plan on having the unit serviced or replaced, combinations thereof, and/or other control responses as desired.

The systems and methods described herein allow for tailored monitoring specific to the particular piece of equipment by determining a normal relationship for that piece of equipment and monitoring deviations from that normal relationship, thereby allowing for improved monitoring of the equipment compared to traditional methods. As an example, an APC in a first pool may have a normal relationship between its two traction motors where both traction motors pull the same amps, and an APC in a second pool may have a normal relationship between its two traction motors where one traction motor pulls more amps than the other traction motor. In other words, the systems and methods described herein account for variances between a normal relationship on an equipment-by-equipment basis and/or on a pool-by-pool basis.

By utilizing a change in relationship between two or more components, which as mentioned may be similar or dissimilar components, the systems and methods described herein also provide improved diagnosis and/or identification of abnormal behavior and/or state of equipment (e.g., failure) that does not rely on human observation. Such improved diagnosis and identification may allow for improved notification to a pool owner and/or control responses, thereby minimizing the impact of the abnormal and/or failed equipment to the to the pool owner.

Various other benefits and advantages may be realized with the devices and methods provided herein, and the aforementioned advantages should not be considered limiting.

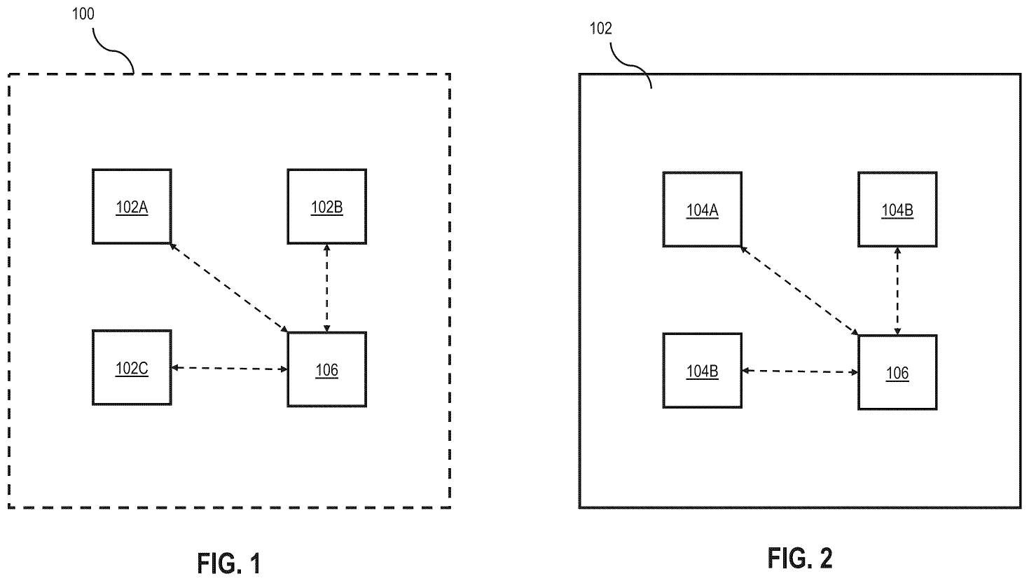

FIG. 1 illustrates an example of a pool system 100 for a swimming pool or spa. The pool system 100 may include one or more pieces of equipment 102 for performing various actions related to performance and maintenance of the pool. Non-limiting examples of equipment 102 include but are not limited to APCs, skimmers, pumps, lights, pool heaters, etc. While FIG. 1 illustrates three pieces of equipment 102A-C, in other embodiments, the pool system 100 may include any number of pieces of equipment 102 as desired, and the equipment provided with the pool system 100 may be various combinations of types of equipment as desired (i.e., the pool equipment 102A-D need not be the same type of pool equipment).

Optionally, the pool system 100 includes a controller 106 (e.g., processor and/or memory) remote from (i.e., not onboard) the equipment 102 while being communicatively and/or operably connected to the equipment 102 (represented by the dashed arrows in FIG. 1). In such embodiments, the controller 106 at least may receive information from the equipment 102. In embodiments with the remote controller 106, the data from the equipment 102 may be provided to the controller 106 via various wired and/or wireless communication techniques as desired. Additionally, or alternatively, the controller 106 and/or one or more additional controllers may be provided on one or more of the pieces of equipment 102. FIG. 2 (discussed below) illustrates the controller 106 on a piece of equipment 102.

Referring to FIG. 2, in various embodiments, one or more of the pool equipment 102 may include various sub-components or devices 104. The sub-components or devices 104 may have one or more operating characteristics during operation of the pool equipment 102. Non-limiting examples of sub-components or devices 104 of equipment 102 according to the embodiments described herein include, but are not limited to, motors, pumps, sensors (e.g., water characteristic sensors, temperature sensors, pressure sensors, proximity sensors, etc.), batteries, accelerometers, other electrical devices, other electrical mechanical devices, other electromechanical devices, and/or other devices or combinations of devices as desired. The operating characteristics for a particular device 104 of the equipment may include various natural characteristics or combinations of characteristics of the device 104 observable as data and/or a signal as desired. Non-limiting examples of operating characteristics include but are not limited to electrical currents, voltages, amps, states of the device (e.g., on/off), communication frequency (e.g., a frequency of receiving data from the device), types of communication, temperatures, pressures, proximities, vibrations, flow rates, rate of battery charge, light intensity, cleaning cycle times, combinations thereof, and/or other operating characteristics as desired. While three devices 104A-C are illustrated with the equipment 102 in FIG. 2, the number of devices should not be considered limiting and a particular piece of pool equipment 102 may include any number of devices 104 as desired. Moreover, the type of device(s) 104 included with a particular piece of equipment 102 may depend on the type of equipment 102.

Optionally, the equipment 102 includes the controller 106, and the controller 106 is communicatively and/or operably connected to the devices 104 (represented by the dashed arrows in FIG. 2) such that the controller 106 onboard the equipment 102 at least may receive information from the devices 104. As previously mentioned, in additional or alternative embodiments, the controller 106 and/or another controller may be remote from (e.g., not onboard) the particular piece of equipment 102.

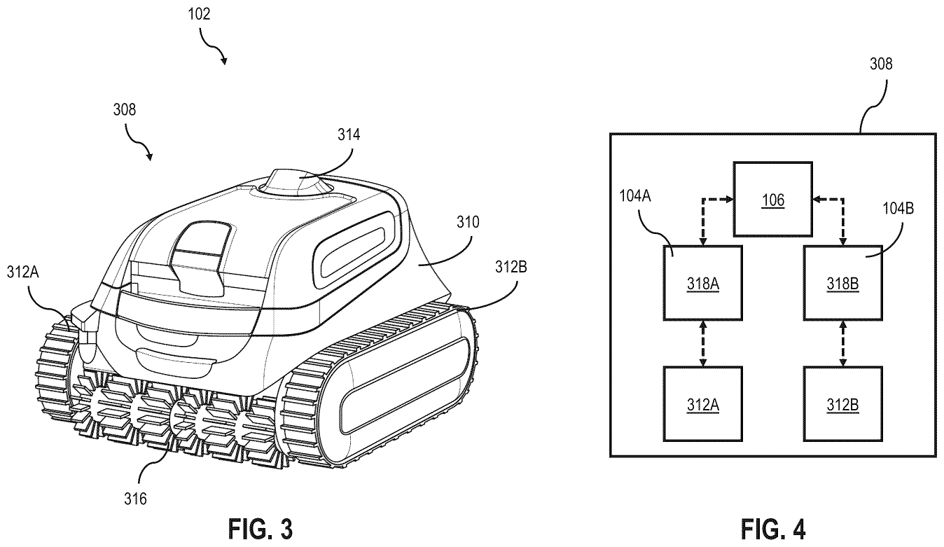

FIGS. 3 and 4 are non-limiting examples of a piece of pool equipment 102 for a swimming pool or spa. FIG. 4 is a block diagram of a portion of the pool equipment 102 illustrated in FIG. 3. In FIGS. 3 and 4, the pool equipment 102 is an APC 308 for cleaning the swimming pool or spa.

The APC 308 may be various types of APCs as desired. As non-limiting examples, the APC 308 may be either “hydraulic” or “robotic” (or “electric”), depending on the source of its motive power. For example, hydraulic APCs typically use pressurized or depressurized water to cause their autonomous movement within pools, while robotic APCs typically use an electric motor to cause their movement. Hydraulic APCs frequently are subcategorized as either “pressure-side” or “suction-side” devices, where pressure-side cleaners receive pressurized water output from an associated water circulation pump while suction-side cleaners are connected to an inlet of the pump.

As illustrated in FIGS. 3 and 4, the APC 308 generally includes a body 310 with one or more inlets and one or more outlets 314. The APC 308 may include one or more of a pump, motive elements 312A-B (e.g., wheels, tracks, etc. such that the APC 308 can move within the swimming pool), an optional cleaning device 316 (e.g., a brush assembly or other suitable device), a filter, any suitable electric or other motors, sensors or sensing devices (e.g., pressure sensors, proximity sensors, etc.), the controller 106 (e.g., processor and memory), an accelerometer, communication modules (e.g., devices facilitating wired and/or wireless communication to and/or form the APC 308, an antenna, sensor, lights, speakers, etc.), and/or an on-board power source (e.g., rechargeable batteries). As best illustrated in FIG. 4, in certain embodiments, traction motors 318A-B are provided for driving each of the motive elements 312A-B. In certain embodiments, the traction motors 318A-B may be the sub-components or devices 104A-B of the APC 308 with operating characteristics that are used by the systems described herein. In other embodiments, other components of the APC 308 (e.g., pump motor, sensors, pump, power source, etc.) may be the device(s) 104, in addition to or in place of the traction motors 318A-B.

As mentioned, the particular APC 308 illustrated in FIGS. 3 and 4 should not be considered limiting, and in other embodiments, other types of APCs may be used with fewer, additional, and/or different combinations or types of features as desired, including various electric cleaners and/or hydraulic cleaners. As mentioned, in other embodiments, additional and/or other types of pool equipment 10 may be utilized, such as but not limited to pumps, pool heaters, skimming devices, combinations thereof, and/or other equipment as desired.

Referring back to FIG. 2, in certain embodiments, the data (i.e., operating characteristic(s)) from each device 104 of a particular piece of equipment 102 may be compared to each other to establish and identify a normal relationship (also referred to herein as a baseline relationship) for the particular piece of equipment 102. Additionally, or alternatively and referring to FIG. 1, a baseline relationship may be determined between similar equipment 102 (e.g., two APCs, two lights, two pumps, etc.) and/or dissimilar equipment in a common pool system 100. In certain embodiments, the baseline relationship between a plurality of pieces of equipment 102 (dissimilar or similar) may include the relationship between a particular piece of equipment 102 and each of the other pieces of equipment 102, between a particular piece of equipment 102 and an average value of particular data of the other pieces of equipment 102, and/or as otherwise desired. As a non-limiting example, the data from a single unit may be compared with the average value of other units under the same environment. In other additional or alternative embodiments, a baseline relationship may be determined between similar equipment 102 (e.g., two APCs, two lights, two pumps, etc.) and/or dissimilar equipment across an aggregate of pool systems 100. As such, the system and methods described herein may construct insight into the baseline/normal behavior and abnormal behavior for various equipment.

As a non-limiting example and referring to FIG. 3, the controller 106 may receive an amp draw of the first traction motor 318A as an operating characteristic of the first traction motor 318A and an amp draw of the second traction motor 318B as an operating characteristic of the second traction motor 318B. In this example, the controller 106 determines a baseline relationship between the traction motors 318A-B by comparing the amp draw of the first traction motor 318A with the amp draw of the second traction motor 318B. As another non-limiting example, for a particular APC, the amp draw for each of the traction motors 318A-B may be generally the same in the baseline relationship. In this example, if one of the traction motors 318A-B begins to consume more current than the other traction motor, this change in the baseline relationship could indicate the APC is failing. As a further non-limiting example, a baseline relationship may be established between a first APC and a second APC. As a further non-limiting example, for a particular pool light, the power draw of the light may be compared to the power draw of each light of a plurality of pool lights and/or the power draw of the particular pool light may be compared to an average power draw of the plurality of pool lights. As another non-limiting example, As yet another non-limiting example, a baseline relationship may be established between a pool light and a skimmer. Baseline relationships may be established between various other similar or dissimilar equipment as desired. As such, while the description makes reference to a comparison between devices 104 on a particular piece of equipment 102, the description is equally applicable to a comparison between two or more pieces or equipment 102, which may be similar or dissimilar. Moreover, such a comparison may be an individual relationship (e.g., data from one unit is compared to data of another unit) or an average relationship (e.g., data from one unit is compared to an average value of data for a plurality of units, optionally within the same environmental conditions).

It is noted that the determination of the baseline relationship does not require that the operating characteristics be equal, the operating characteristics be the same type of operating characteristic, and/or the devices 104 compared be a same type of device 104. As an example, and referring to the traction motors 318A-B, the controller 106 may identify the baseline relationship as one where the first traction motor 318A draws more amps compared to the second traction motor 318B. As another example and referring to the traction motors 318A-B, the controller 106 may identify the baseline relationship between the motors 318A-B using the amp draw of the first traction motor 318A and a temperature of the second traction motor 318B as the operating characteristics. As yet another example and referring to FIG. 2, in some embodiments, the devices 104A-B are both a same type of electromechanical device, while in other embodiments, a first device 104A of the equipment 102 may be a traction motor and a second device 104B of the equipment 102 may be a temperature sensor, and the controller 106 determines a baseline relationship between the traction motor and the temperature sensor.

In various embodiments, the systems described herein may monitor the baseline relationship between devices 104 of a particular piece of equipment 102 and/or the baseline relationship between similar equipment 102 and/or dissimilar equipment 102. The systems described herein may identify or determine a behavior of a particular piece equipment 102 based on a change in the relationship between the compared devices 104 of the equipment 102. Additionally, or alternatively, the behavior of equipment 102 may be determined based on a change in the relationship between the particular equipment 102 and other equipment 102. In certain embodiments, the systems described herein may determine an abnormal behavior and/or state of the equipment 102 based on a change in the relationship of the devices 104 of the particular equipment 102 and/or relative to other equipment 102 of the particular pool system 100. Non-limiting examples of a change in relationship may include but are not limited to abnormally high or low values, a change in values, trends of changes in values, a divergence in values, something that normally has a value goes to 0 or vice versa, combinations thereof, and/or other changes in relationship as desired. As a non-limiting example and referring back to the example of FIG. 3 with the traction motors 318A-B, the system may identify a normal relationship when the first traction motor 318A generally pulls the same amps as the second traction motor 318B, and may identify an abnormal behavior or state of the APC 308 based on the first traction motor 318A gradually pulling more amps compared to the second traction motor 318B.

In certain embodiments, based on an identified change in relationship between two or more devices 104 of a particular piece of equipment and/or relative to similar equipment and/or dissimilar equipment 102 of the same pool system 100, the systems described herein may determine and/or implement a control response. Various types and/or combinations of control responses may be determined and/or generated as desired. As one non-limiting example, the control response may be providing a notification or alert of the abnormal behavior or state to a pool owner, a pool technician, and/or a dealer of the pool equipment. Such an alert or notification optionally may be generated on a remote device, such as but not limited to a remote personal device or computing device using an application. As another non-limiting example, the control response may be an alert or notification on the piece of equipment 102 (e.g., by controlling a light source on the equipment, generating an auditory alert on the equipment, generating a text or other visual alert on the equipment, etc.). In another non-limiting example, the control response includes a prediction of a time period of future failure of the equipment and optionally providing the predicted time period to failure to the pool owner, technician, etc. In additional non-limiting examples, the control response may include predicting and/or diagnosing a type of problem based on the abnormal behavior or state. As a non-limiting example, the controller may identify a temporary problem (e.g., clogged filter on an APC or encountered obstruction in the pool or that the APC is trapped/stuck) based on a first change in relationship and a lasting problem (e.g., failing traction motor) based on a second change in relationship. In further non-limiting examples, the control response may include initiating the sending of a replacement piece of equipment 102 and/or device 104 of the equipment 104. Various other types of control responses may be determined and/or generated as desired, and the aforementioned examples should not be considered limiting.

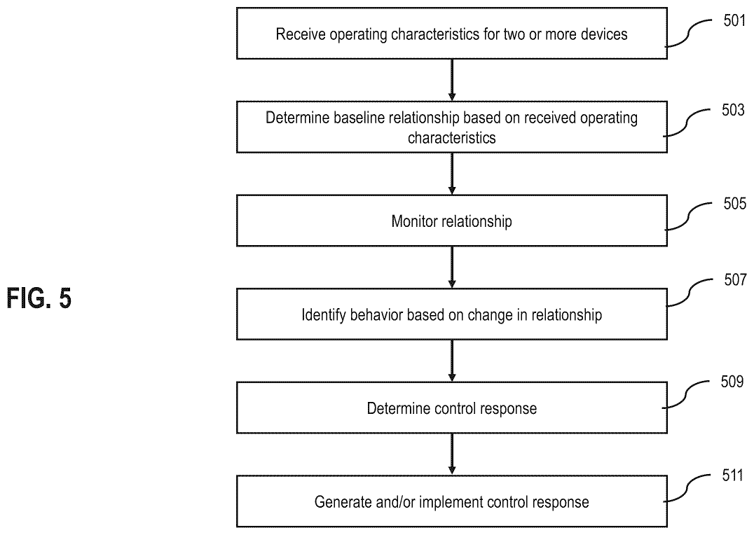

Referring to FIGS. 5-7, a method of controlling equipment 102 of a pool system 100 is described in greater detail. The method illustrated may be performed in real-time (e.g., during operation of the equipment 102), after completion of a particular operation of the equipment 102, and/or as otherwise desired. The method is described in the context of comparing devices 104 of a particular piece of equipment 102, but the method is equally applicable to comparing a plurality of pieces of equipment 102 unless expressly stated to the contrary.

In a block 501, the method includes receiving operating characteristics for two or more devices 104 of a particular piece of equipment 102. In block 501, the two or more devices 104 may be a same type of device 104 (e.g., each device is a motor, each device is a pump, each device is a sensor, etc.) or dissimilar (e.g., one device is a motor and another device is a sensor). In one non-limiting example, the equipment 102 is the APC 308, and the two or more devices are similar electromechanical devices such as but not limited to traction motors. The operating characteristics in block 501 may be a same type of operating characteristic (e.g., each operating characteristic is an amp draw, each characteristic is a current, each characteristic is a vibration, each characteristic is a temperature, etc.) or different types of operating characteristics (e.g., one operating characteristic is an amp draw and another operating characteristic is a temperature). Additionally, or alternatively, block 501 includes receiving operating characteristics for a plurality of pieces of equipment 102 (e.g., a plurality of APCs, lights, pumps, heaters, combinations thereof, etc.). In various embodiments, receiving the operating characteristics in block 501 may be performed contemporaneously with each other.

In a block 503, the method includes determining a baseline relationship between the two or more devices 104 of the particular piece of equipment 102 (and/or the baseline relationship between two or more pieces of equipment 102). In block 505, the method includes monitoring the relationship between the two or more devices 104 (and/or the two or more pieces of equipment 102).

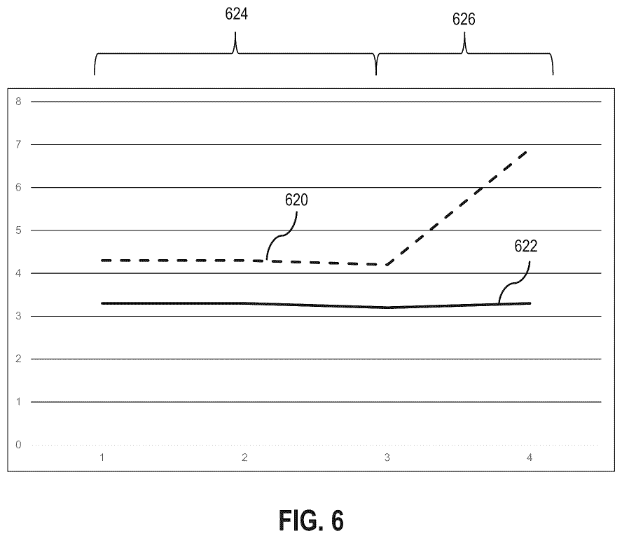

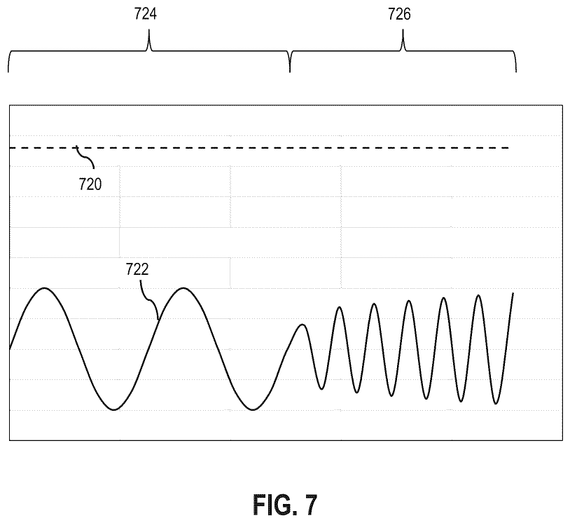

FIG. 6 illustrates a non-limiting example of a baseline relationship 624 that may be established between an operating characteristic of a first device (represented by line 620) (and/or a first piece of equipment 102) and an operating characteristic of a second device (represented by line 622) (and/or an operating characteristic of second piece of equipment 102 similar or dissimilar to the first device, and/or an operating characteristic of a plurality of pieces of equipment 102, and/or an average value of an operating characteristic of a plurality of pieces of equipment 102). In the example of FIG. 6, the operating characteristics 620, 622 have a generally linear or parallel relationship in their baseline relationship 624. A non-limiting example of the relationship between two devices 104 represented by FIG. 6 may be relative amp draws from a first traction motor and a second traction motor of an APC. FIG. 7 illustrates another non-limiting example of a baseline relationship 724 that may be established between an operating characteristic of a first device (represented by line 720) and an operating characteristic of a second device (represented by line 722) (and/or an operating characteristic of second piece of equipment 102 similar or dissimilar to the first device, and/or an operating characteristic of a plurality of pieces of equipment 102, and/or an average value of an operating characteristic of a plurality of pieces of equipment 102). In the example of FIG. 7, in the baseline relationship 724, the operating characteristic 720 has a generally linear pattern while the operating characteristic 722 has a periodic pattern with a particular frequency and/or amplitude. A non-limiting example of the relationship between two devices 104 represented by FIG. 7 may be an amp draw from a traction motor and a communication frequency from a temperature sensor of an APC. The baseline relationships 624, 724 are for illustrative purposes only and should not be considered limiting on the disclosure.

In a block 507 of FIG. 5, the method includes determining an abnormal behavior or state of the equipment 102 based on a change in the relationship determined in block 503. FIGS. 6 and 7 illustrate two non-limiting examples of changes in relationships from a baseline relationship that may be used to identify an abnormal behavior or state in block 507. Referring to FIG. 6, an abnormal state 626 may be identified based the increasing and/or deviating relationship between the characteristics 620, 622 compared to the linear or parallel relationship in the baseline relationship 624. A non-limiting example of the abnormal state 626 relationship between two devices 104 represented by FIG. 6 may be a relative increasing amp draw of a first traction motor of an APC compared to a second traction motor of the APC. Referring to FIG. 7, an abnormal state 726 may be identified based on the changed relative signal patterns (e.g., the operating characteristic 722 has an increased frequency and/or decreased amplitude) from the relative signal patterns of the baseline relationship 724. A non-limiting example of the abnormal state 726 relationship between two devices 104 represented by FIG. 6 may be a relative increasing communication frequency from the temperature sensor, thereby changing its pattern compared to an amp draw of the traction motor of the APC. The abnormal states 626, 726 are for illustrative purposes only and should not be considered limiting on the disclosure.

Referring back to FIG. 5, in an optional block 509, the method includes determining one or more control responses based on the abnormal behavior or state of the equipment 102 determined in block 507. In an optional block 511, the method includes generating and/or implementing the one or more control responses determined in optional block 509.

The systems and methods described herein provide improved techniques for identifying a behavior and/or state of the pool equipment based on the relationship between two or more devices of a particular piece of equipment. The systems and methods described herein also provide improved techniques for identifying a behavior and/or state of a particular piece of equipment relative to other similar and/or dissimilar equipment within a common pool system. The systems and methods described herein allow for tailored monitoring specific to the particular piece of equipment and allow for improved identification of abnormal behavior and/or states of pool equipment, thereby allowing for quicker control responses to address such abnormal behavior and/or states.

Exemplary concepts or combinations of features of the invention may include:
A. A method of controlling an APC, the method comprising (i) comparing characteristics of at least two similar electromechanical devices of the APC to establish a normal relationship between the at least two similar electromechanical devices, and (ii) identifying abnormal behavior of the APC based on a divergence from the normal relationship.
B. The method of any preceding or subsequent statement or combination of statements, wherein the two similar electromechanical devices comprise two traction motors or two sensors of the APC.
C. The method of any preceding or subsequent statement or combination of statements, further comprising generating a control response based on the identification of abnormal behavior.
D. The method of any preceding or subsequent statement or combination of statements, wherein generating the control response comprises at least one of predicting a future failure by the APC, sending a notification to a user, sending a notification to a servicer, or ordering a replacement component.
E. The method of any preceding or subsequent statement or combination of statements, wherein the characteristics of the at least two similar electromechanical devices comprise one or more of an electrical current, power draw, a voltage, a state, or operational data.
F. An APC for a swimming pool or spa, the APC comprising a controller, a first electromechanical device, and a second electromechanical device, wherein the controller is configured to (i) determine a normal relationship between the first electromechanical device and the second electromechanical device by comparing a characteristic of the first electromechanical device with a characteristic of the second electromechanical device and (ii) identify abnormal behavior of the APC based on a divergence from the normal relationship.
G. The APC of any preceding or subsequent statement or combination of statements, wherein the first electromechanical device and the second electromechanical device are of the same type.
H. A method comprising receiving signals from at least two devices of an APC, determining a normal relationship between the at least two devices based on the received signals, and identifying behavior of the APC based on a change in relationship between the signals, wherein the signals correspond with operating characteristics of the at least two devices.
I. The method of any preceding or subsequent statement or combination of statements, wherein the signals comprise electrical signals, sound signals, or optical signals.
J. The method of any preceding or subsequent statement or combination of statements, wherein the at least two devices are similar devices of the APC.
K. The method of any preceding or subsequent statement or combination of statements, wherein the at least two devices are dissimilar devices of the APC.
L. The method of any preceding or subsequent statement or combination of statements, wherein the operating characteristics of the at least two devices are a same type of operating characteristic.
M. The method of any preceding or subsequent statement or combination of statements, wherein the operating characteristic of a first device of the at least two devices is a first type of operating characteristic, and wherein the operating characteristic of a second device of the at least two devices is a second type of operating characteristic different from the first type of operating characteristic.
N. The method of any preceding or subsequent statement or combination of statements, wherein the operating characteristics comprise at least one of a temperature, a pressure, a current, a voltage, or a communication frequency.
O. An APC for a swimming pool or spa, the APC comprising a controller and at least two devices, each of the at least two devices comprising an operating characteristic, wherein the controller is configured to receive signals from the at least two devices of the APC, determine a normal relationship between the at least two devices based on the received signals, and identify behavior of the APC based on a change in relationship between the signals.
P. A method of controlling equipment of a pool or spa system, the method comprising (i) determining a normal relationship between a first device and a second device by comparing an operating characteristic of the first device with an operating characteristic of the second device, and (ii) identifying a change in behavior of the pool or spa system based on a change in relationship between the operating characteristic of the first device and the operating characteristic of the second device.
Q. The method of any preceding or subsequent statement or combination of statements, wherein the first device and the second device are components of a same piece of equipment.
R. The method of any preceding or subsequent statement or combination of statements, wherein the equipment comprises an APC, a heater, or a pump of the pool or spa system.
S. The method of any preceding or subsequent statement or combination of statements, wherein the first device and the second device are on different pieces of equipment of the pool or spa system.
T. A method comprising comparing characteristics of at least two similar electromechanical devices of an APC and predicting a time period to failure of the APC based on a change in relationship between characteristics of the at least two similar electromechanical devices.
U. A method comprising receiving data from a plurality of devices of an APC, determining a normal relationship between the plurality of devices of the APC based on the received data, and identifying a condition of the APC based on a change in a pattern of the received data from the normal relationship.
V. A method comprising comparing a plurality devices of an APC to each other with regards to a common characteristic, and identifying an abnormal condition of the APC based on a divergent relationship of the common characteristic of the plurality of devices of the APC.
W. A pool system comprising: a controller; and a plurality of devices, wherein the controller is configured to: (i) determine a normal relationship fora first device of the plurality of devices by comparing an operating characteristic of the first device with either (a) an operating characteristic of a second device of the plurality of devices or (b) an average value of an operating characteristic of the plurality of devices; and (ii) identify a change in behavior of the pool or spa system based on a change in relationship between the operating characteristic of the first device and the operating characteristic of the second device.
X. The pool system of any preceding or subsequent statement or combination of statements, wherein the plurality of devices are of the same type.
Y. The pool system of any preceding or subsequent statement or combination of statements, wherein the plurality of devices comprise two traction motors of an automatic swimming pool cleaner or two sensors of the automatic swimming pool cleaner.
Z. The pool system of any preceding or subsequent statement or combination of statements, wherein the plurality of devices are components of a same piece of equipment.
AA. The pool system of any preceding or subsequent statement or combination of statements, wherein the piece of equipment comprises at least one of a pump, and automatic swimming pool cleaner, a heater, a skimmer, or a pool light.
BB. The pool system of any preceding or subsequent statement or combination of statements, where the first device of the plurality of devices is a component of a first piece of equipment of the pool system and the second device of the plurality of devices is a component of a second piece of equipment of the pool system.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. In the figures and the description, like numerals are intended to represent like elements. As used herein, the meaning of “a,” “an,” and “the” includes singular and plural references unless the context clearly dictates otherwise.

Further, although applicant has described devices and techniques for use principally with pool equipment with surfaces contacting pool water, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A method of controlling an automatic swimming pool cleaner (APC), the method comprising (i) comparing characteristics of at least two similar electromechanical devices of the APC to establish a normal relationship between the at least two similar electromechanical devices, and (ii) identifying abnormal behavior of the APC based on a divergence from the normal relationship.

2. The method of claim 1, wherein the two similar electromechanical devices comprise two traction motors of the APC.

3. The method of claim 1, wherein the two similar electromechanical devices comprise two sensors of the APC.

4. The method of claim 1, further comprising generating a control response based on the identification of abnormal behavior.

5. The method of claim 4, wherein generating the control response comprises at least one of predicting a future failure by the APC, sending a notification to a user, sending a notification to a servicer, or ordering a replacement component.

6. The method of claim 1, wherein the characteristics of the at least two similar electromechanical devices comprise one or more of an electrical current, power draw, a voltage, a state, or operational data.

7. A pool system comprising:
a controller; and
a plurality of devices,
wherein the controller is configured to:
(i) determine a normal relationship for a first device of the plurality of devices by comparing an operating characteristic of the first device with either (a) an operating characteristic of a second device of the plurality of devices or (b) an average value of an operating characteristic of the plurality of devices; and
(ii) identify a change in behavior of the pool or spa system based on a change in relationship between the operating characteristic of the first device and the operating characteristic of the second device.

8. The pool system of claim 7, wherein the plurality of devices are of the same type.

9. The pool system of claim 8, wherein the plurality of devices comprise two traction motors of an automatic swimming pool cleaner or two sensors of the automatic swimming pool cleaner.

10. The pool system of claim 7, wherein the plurality of devices are components of a same piece of equipment.

11. The pool system of claim 10, wherein the piece of equipment comprises at least one of a pump, and automatic swimming pool cleaner, a heater, a skimmer, or a pool light.

12. The pool system of claim 7, where the first device of the plurality of devices is a component of a first piece of equipment of the pool system and the second device of the plurality of devices is a component of a second piece of equipment of the pool system.

13. The pool system of claim 12, wherein the first piece of equipment and the second piece of equipment are a same type of equipment.

14. The pool system of claim 12, wherein the first piece of equipment and the second piece of equipment are different types of equipment.

15. A method of controlling equipment of a pool or spa system, the method comprising determining a normal relationship between a first device and a second device by comparing an operating characteristic of the first device with an operating characteristic of the second device, and (ii) identifying a change in behavior of the pool or spa system based on a change in relationship between the operating characteristic of the first device and the operating characteristic of the second device.

16. The method of claim 15, wherein the signals comprise electrical signals, sound signals, or optical signals.

17. The method of 15, wherein the first device and the second device are components of a same piece of pool equipment.

18. The method of claim 15, wherein the first device is a component of a first piece of pool equipment and the second device is a component of a second piece of pool equipment.

19. The method of claim 15, wherein the operating characteristics of the first device and the second device are a same type of operating characteristic.

20. The method of claim 15, wherein the operating characteristic of a first device of the at least two devices is a first type of operating characteristic, and wherein the operating characteristic of a second device of the at least two devices is a second type of operating characteristic different from the first type of operating characteristic.
